(19) United States
(12) Patent Application Publication
(10) Pub. No.: US 2023/0347939 A1
(43) Pub. Date: Nov. 2, 2023

(54) DRIVING ASSISTANCE DEVICE

(71) Applicant: Panasonic Intellectual Property Management Co., Ltd., Osaka (JP)

(72) Inventors: Masashi NAKANO, Kanagawa Ken (JP); Ken NAKAOKA, Kanagawa Ken (JP); Tomoya URUSHIHARA, Kanagawa Ken (JP)

(73) Assignee: Panasonic Intellectual Property Management Co., Ltd., Osaka (JP)

(21) Appl. No.: 18/220,665

(22) Filed: Jul. 11, 2023

Related U.S. Application Data
(63) Continuation of application No. PCT/JP2021/045409, filed on Dec. 9, 2021.

(30) Foreign Application Priority Data
Feb. 3, 2021 (JP) 2021-016109

(51) Int. Cl. B60W 60/00; B60W 50/14

(52) U.S. Cl. CPC B60W 60/0027; B60W 50/14; B60W 2554/80; B60W 2554/4041; B60W 2050/146

(57) ABSTRACT

A driving assistance device according to the present disclosure is capable of being mounted on a vehicle. The vehicle includes: a vehicle body; a detection device capable of detecting a state around the vehicle; and a display unit visually recognizable by a driver. The driving assistance device includes: a memory; and a processor configured to: determine whether the two vehicles are allowed to pass each other based on the state, size information of a vehicle body of another vehicle, and a size of the vehicle body of the vehicle; search for, when determining that passing between the two vehicles is not performable, a first evacuation candidate area to which the vehicle is allowed to evacuate based on the state detected along a traveling trajectory of the vehicle by the detection device; and display a search result of the first evacuation candidate area on the display unit.

### CROSS-REFERENCE TO RELATED APPLICATIONS

This application is a continuation of International Application No. PCT/JP2021/045409, filed on Dec. 9, 2021 which claims the benefit of priority of the prior Japanese Patent Application No. 2021-016109, filed on Feb. 3, 2021, the entire contents of which are incorporated herein by reference.

### FIELD

Embodiments described herein relate generally to a driving assistance device.

### BACKGROUND

Conventionally, there is known a technique of searching for a surrounding evacuation place by using a map database or the like when it is difficult to pass an oncoming vehicle (e.g., see JP 2008-174023 A and JP 6699647 B2).

The present disclosure provides a driving assistance device capable of providing an appropriate evacuation place depending on an actual road situation when it is difficult to pass an oncoming vehicle.

### SUMMARY

A driving assistance device according to the present disclosure is capable of being mounted on a vehicle. The vehicle includes: a first wheel; a second wheel; a vehicle body coupled to the first wheel and the second wheel, the vehicle body being movable by the first wheel and the second wheel; a detection device capable of detecting a state around the vehicle; a communication unit capable of receiving, from another vehicle, other vehicle information on the other vehicle; and a display unit visually recognizable by a driver. The other vehicle information includes information on a size of a vehicle body of the other vehicle. The driving assistance device includes: a memory; and a processor coupled to the memory and configured to: determine whether the vehicle and the other vehicle are allowed to pass each other based on the state around the vehicle, the information on the size of the vehicle body of the other vehicle, and a size of the vehicle body of the vehicle; search for, when determining that passing between the vehicle and the other vehicle is not performable, a first evacuation candidate area to which the vehicle is allowed to evacuate based on the state around the vehicle detected along a traveling trajectory of the vehicle by the detection device; and display a search result of the first evacuation candidate area on the display unit.

### BRIEF DESCRIPTION OF THE DRAWINGS

FIG. 1 is a diagram illustrating an example of a vehicle including a driving assistance device according to a first embodiment;

FIG. 2 is a block diagram illustrating an example of a configuration of the driving assistance device according to the first embodiment;

FIG. 3 is a diagram illustrating an example of empty space information according to the first embodiment;

FIG. 4 is a diagram illustrating an example of a positional relationship between the vehicle and the other vehicle according to the first embodiment;

FIG. 5 is a diagram illustrating an example of a passing point according to the first embodiment;

FIG. 6 is a diagram illustrating an example of an evacuation destination guidance screen displayed on a display according to the first embodiment;

FIG. 7 is a diagram illustrating an example of a hardware configuration of the driving assistance device according to the first embodiment;

FIG. 8 is a flowchart illustrating an example of a flow of passing assistance processing according to the first embodiment;

FIG. 9 is a block diagram illustrating an example of a configuration of a driving assistance device according to a second embodiment;

FIG. 10 is a diagram illustrating an example of a positional relationship between a vehicle and the other vehicle according to the second embodiment;

FIG. 11 is a diagram illustrating an example of an evacuation request screen displayed on a display of the other vehicle according to the second embodiment;

FIG. 12 is a diagram illustrating an example of a situation report screen of an evacuation request displayed on a display of the vehicle according to the second embodiment;

FIG. 13 is a flowchart illustrating an example of a flow of passing assistance processing according to the second embodiment; and

FIG. 14 is a diagram illustrating an example of a positional relationship between a vehicle and the other vehicle according to a seventh modification.

### DETAILED DESCRIPTION

Hereinafter, embodiments of a driving assistance device according to the present disclosure will be described with reference to the accompanying drawings.

### First Embodiment

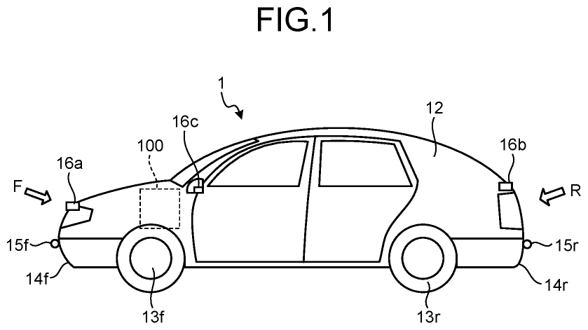

FIG. 1 is a diagram illustrating an example of a vehicle 1 including a driving assistance device 100 according to a first embodiment. As illustrated in FIG. 1, the vehicle 1 includes a vehicle body 12 and two pairs of wheels 13 disposed in a predetermined direction on the vehicle body 12. The two pairs of wheels 13 include a pair of front tires 13f and a pair of rear tires 13r.

The front tire 13f illustrated in FIG. 1 is an example of a first wheel in the present embodiment. The rear tire 13r is an example of a second wheel in the present embodiment. Although the vehicle 1 illustrated in FIG. 1 includes four wheels 13, the number of wheels 13 is not limited thereto. For example, the vehicle 1 may be a two-wheeled vehicle.

The vehicle body 12 is coupled to the wheels 13 and is movable by the wheels 13. In this case, a predetermined direction in which the two pairs of wheels 13 are disposed is a traveling direction (moving direction) of the vehicle 1. The vehicle 1 can move forwards or rearwards by switching a gear (not illustrated) or the like. The vehicle 1 can also turn right or left by steering.

The vehicle body 12 has a front end portion F which is an end portion on the front tire 13f side and a rear end portion R which is an end portion on the rear tire 13r side. The vehicle body 12 has a substantially rectangular shape in top view, and four corners of the substantially rectangular shape may be referred to as end portions. Although not illustrated in FIG. 1, the vehicle 1 includes a display, a speaker, and an operation unit.

A pair of bumpers 14 is provided near the lower end of the vehicle body 12 at the front and rear end portions F and R of the vehicle body 12. Among the pair of bumpers 14, a front bumper 14f covers the entire front surface and a part of the side surface in the vicinity of the lower end portion of the vehicle body 12. A rear bumper 14r of the pair of bumpers 14 covers the entire rear surface and a part of the side surface in the vicinity of the lower end portion of the vehicle body 12.

Wave transmitter/receivers 15f and 15r that transmit and receive a sound wave such as an ultrasonic wave are disposed at a predetermined end portion of the vehicle body 12. For example, one or more wave transmitter/receivers 15f are disposed on the front bumper 14f, and one or more wave transmitter/receivers 15r are disposed on the rear bumper 14r. Hereinafter, in a case where the wave transmitter/receivers 15f and 15r are not particularly limited, the same are simply referred to as a wave transmitter/receiver 15. In addition, the number and position of the wave transmitter/receiver 15 are not limited to the example illustrated in FIG. 1. For example, the vehicle 1 may include the wave transmitter/receiver 15 on the left and right sides.

In the present embodiment, a sonar using an ultrasonic wave will be described as an example of the wave transmitter/receiver 15, but the wave transmitter/receiver 15 may be a radar that transmits and receives an electromagnetic wave. Alternatively, the vehicle 1 may include both a sonar and a radar. Further, the wave transmitter/receiver 15 may be simply referred to as a sensor.

More specifically, the wave transmitter/receiver 15 includes a wave transmitter that transmits a sound wave such as an ultrasonic wave or an electromagnetic wave, and a wave receiver that receives a reflected sound wave in which the sound wave or the electromagnetic wave transmitted from the wave transmitter is reflected by an object. Further, a result of transmission and reception of a sound wave or an electromagnetic wave by the wave transmitter/receiver is used for detection of an object around the vehicle 1 and measurement of a distance between the object and the vehicle 1 by a distance measurement device to be described later. The distance measurement device is not illustrated in FIG. 1.

In addition, the vehicle 1 includes a first image capturing device 16a that captures an image forward of the vehicle 1, a second image capturing device 16b that captures an image rearward of the vehicle 1, a third image capturing device 16c that captures an image of the left side of the vehicle 1, and a fourth image capturing device that captures an image of the right side of the vehicle 1. The fourth image capturing device is not illustrated in FIG. 1.

Hereinafter, the first image capturing device 16a, the second image capturing device 16b, the third image capturing device 16c, and the fourth image capturing device will be simply referred to as an image capturing device 16, unless otherwise distinguished. Furthermore, in the present embodiment, the vehicle 1 only needs to include at least the third image capturing device 16c and the fourth image capturing device, and the first image capturing device 16a and the second image capturing device 16b are not essential. Furthermore, the vehicle 1 may further include another image capturing device in addition to the above-described example. Furthermore, in the present embodiment, the image capturing device 16 may be included in a sensor.

The image capturing device 16 can capture an image around the vehicle 1, and is, for example, a camera that captures a color image. Note that the captured image captured by the image capturing device 16 may be a moving image or a still image. Furthermore, the image capturing device 16 may be a camera built in the vehicle 1, a camera of a drive recorder retrofitted to the vehicle 1, or the like.

In the present embodiment, the wave transmitter/receiver 15 and the image capturing device 16 are an example of a detection device capable of detecting a surrounding state. Note that only the wave transmitter/receiver 15 may be an example of the detection device, or only the image capturing device 16 may be an example of the detection device.

Further, the driving assistance device 100 is mounted on the vehicle 1. The driving assistance device 100 is an information processing device that can be mounted on the vehicle 1, and is, for example, an electronic control unit (ECU) or an on board unit (OBU) provided inside the vehicle 1. Alternatively, the driving assistance device 100 may be an external device installed near a dashboard of the vehicle 1. A hardware configuration of the driving assistance device 100 will be described later. The driving assistance device 100 may also serve as a car navigation device or the like.

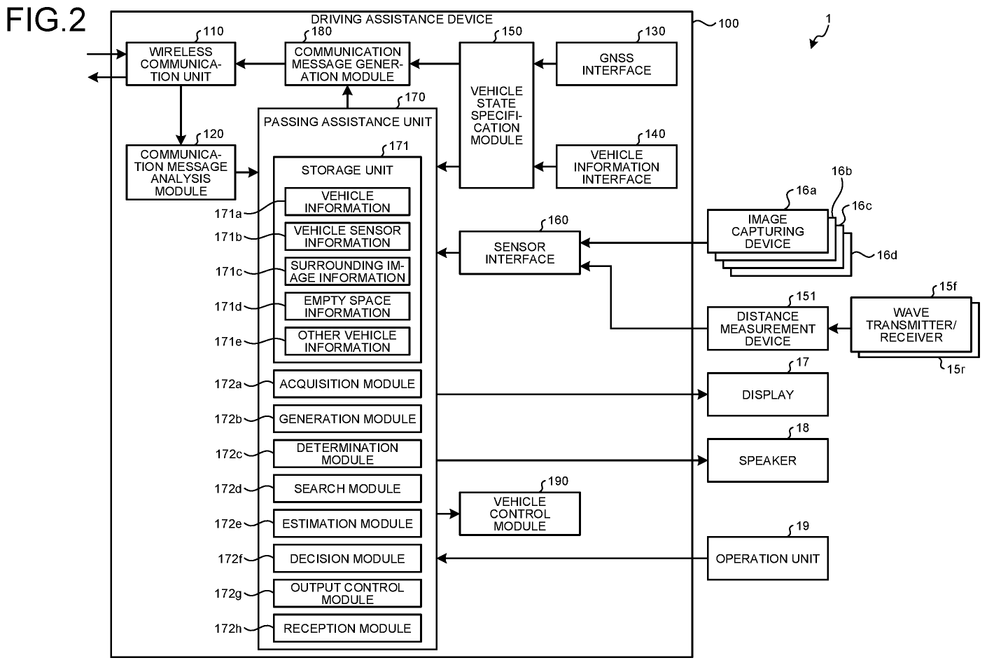

FIG. 2 is a block diagram illustrating an example of a configuration of the driving assistance device 100 according to the first embodiment. As illustrated in FIG. 2, the driving assistance device 100 includes a wireless communication unit 110, a communication message analysis module 120, a global navigation satellite system (GNSS) interface 130, a vehicle information interface 140, a vehicle state specification module 150, a sensor interface 160, a passing assistance unit 170, a communication message generation module 180, and a vehicle control module 190.

As described above, the vehicle 1 includes a display 17, a speaker 18, and an operation unit 19. The display 17, the speaker 18, and the operation unit 19 are provided around the driver's seat in the vehicle body 12. The driving assistance device 100 is connected to the display 17, the speaker 18, and the operation unit 19 in a wired or wireless manner.

For example, the display 17 is visually recognizable by a driver, and is an example of a display unit in the present embodiment. The display 17 is a liquid crystal display, an organic electro-luminescence (EL) display, or the like. Note that the display 17 may be a display unit of a car navigation device mounted on the vehicle 1.

The speaker 18 can notify a driver of a message by voice. The display 17 and the speaker 18 may be collectively referred to as a notification unit.

The operation unit 19 is a button, a touch panel, or the like that can be operated by a user such as a driver or a passenger. Note that the operation unit 19 and the display 17 may be formed as a touch panel on which a driver or a passenger can perform a touch operation.

The vehicle control module 190 can control at least one of acceleration/deceleration, braking, and steering of the vehicle 1. For example, the vehicle control module 190 moves the vehicle 1 by automatic driving control. In addition, the present embodiment includes not only normal automatic driving control for controlling the behavior of the vehicle 1 when the vehicle 1 travels on a road, but also parking assistance for assisting parking of the vehicle 1 at a target position.

When the passing assistance unit 170 described later determines that the vehicle 1 and the other vehicle 2 cannot move forwards and cannot pass each other, the vehicle control module 190 moves the vehicle 1 by automatic driving to a first evacuation candidate area specified by the passing assistance unit 170.

In FIG. 2, the vehicle control module 190 is illustrated separately from the passing assistance unit 170, but the vehicle control module 190 may be included in the passing assistance unit 170.

The wireless communication unit 110 transmits and receives information to and from the other vehicle or a roadside device by a communication unit such as vehicle-to-cellular-network (V2X). The wireless communication unit 110 is an example of a communication unit in the present embodiment.

Note that a communication method is based on, for example, the IEEE Wi-Fi (registered trademark) protocol or the like, but is not particularly limited thereto. Further, the information received by the wireless communication unit 110 may be information specified with the vehicle 1 as a destination, or may be information broadcasted from the other vehicle or a roadside device to the surroundings. In the present embodiment, the information transmitted by V2X communication from the other vehicle or the roadside device is referred to as a communication message.

In the present embodiment, the wireless communication unit 110 can receive the other vehicle information on the other vehicle broadcasted from the other vehicle by V2X communication. In addition, the wireless communication unit 110 may broadcast vehicle information related to the vehicle 1 to the surroundings.

In the present embodiment, the other vehicle information includes information related to a size of a vehicle body of the other vehicle. More specifically, the other vehicle information includes information on a vehicle width and a vehicle length of the other vehicle.

In addition, the wireless communication unit 110 broadcasts a message generated by the communication message generation module 180 to the surroundings of the vehicle 1.

The communication message analysis module 120 analyzes information received by the wireless communication unit 110 from the other vehicle or the roadside device. For example, the communication message analysis module 120 analyzes the other vehicle information from a signal broadcasted by the other vehicle. The communication message analysis module 120 may perform signal conversion processing or specific information extraction processing. The communication message analysis module 120 sends the analyzed other vehicle information to the passing assistance unit 170.

The communication message generation module 180 acquires vehicle information 171a including the vehicle width and the vehicle length of the vehicle 1 from a storage unit 171 of the passing assistance unit 170, and generates a communication message including the information. The communication message generation module 180 sends the generated message to the wireless communication unit 110. Furthermore, the communication message generation module 180 may acquire information regarding the vehicle state including the speed and the like of the vehicle 1 from the vehicle state specification module 150, and may include the information in the communication message.

The GNSS interface 130 acquires position information based on a global positioning system (GPS) signal received from a GPS satellite by a GPS module (not illustrated) mounted on the vehicle 1. In the present embodiment, GNSS coordinates are given as an example of the position information of the vehicle 1, but the position of the vehicle 1 may be specified by another method.

The vehicle information interface 140 is an interface that acquires information on the state of the vehicle 1. The information on the state of the vehicle 1 is, for example, a speed, a steering angle, an acceleration, and the like of the vehicle 1. The vehicle information interface 140 acquires these pieces of information from other ECUs or various sensors of the vehicle 1 via, for example, a controller area network (CAN).

The vehicle state specification module 150 specifies the state of the vehicle 1 based on the position information, the speed, the steering angle, the acceleration, and the like of the vehicle 1 acquired from the GNSS interface 130 and the vehicle information interface 140. The state of the vehicle 1 includes, for example, the position and the speed of the vehicle 1. The vehicle state specification module 150 may specify the position of the vehicle 1 with high accuracy by correcting the position information based on the GPS signal based on the speed, the steering angle, the acceleration, and the like of the vehicle 1.

The sensor interface 160 acquires information from the first to fourth image capturing devices 16a to 16d and a distance measurement device 151. Note that, in FIG. 2, the first to fourth image capturing devices 16a to 16d are simply referred to as an “image capturing device”. Further, the sensor interface 160 sends the acquired information to the passing assistance unit 170.

More specifically, the sensor interface 160 acquires an image around the vehicle 1 from the image capturing device 16. In the present embodiment, the sensor interface 160 acquires an image obtained by capturing the side of the vehicle 1 from at least the third image capturing device 16c and the fourth image capturing device 16d. In addition, the sensor interface 160 acquires a distance between an object around the vehicle 1 and the vehicle 1 from the distance measurement device 151.

The distance measurement device 151 detects the object around the vehicle 1 based on a result of transmission and reception of a sound wave or an electromagnetic wave by the wave transmitter/receiver 15. For example, the distance measurement device 151 detects the object from a reflected sound wave received by the wave receiver. The distance measurement device 151 transmits a distance to the object around the vehicle 1 to the sensor interface 160.

The object around the vehicle 1 is, for example, a preceding vehicle, a following vehicle, a wall, a utility pole, a street tree, a building along a road, or the like. These objects may be simply referred to as obstacles.

Since the transmission range of the wave transmitter/receiver 15 and the imaging range of the image capturing device 16 change with the traveling of the vehicle 1, the sensor interface 160 acquires a result of detecting the state around the vehicle 1 along the traveling trajectory of the vehicle 1 in time series. The result of detecting the state around the vehicle 1 is, for example, an obstacle around the vehicle 1 and an image around the vehicle 1.

The passing assistance unit 170 assists a driver when the vehicle 1 passes the other vehicle.

In the present embodiment, “passing” means that the vehicle 1 passes an oncoming vehicle traveling in the same lane as the lane in which the vehicle 1 travels in opposite directions. In the present embodiment, the oncoming vehicle is referred to as “the other vehicle”. In addition, a case where the vehicle 1 and the other vehicle are traveling in different lanes and a case where the traveling directions of the vehicle 1 and the other vehicle are the same are excluded from “passing” in the present embodiment. For example, in a case where a road on which the vehicle 1 travels is a one-lane road, the “passing” includes a situation in which the other vehicle traveling from the traveling direction of the vehicle 1 and the vehicle 1 travel and pass each other, or a situation in which any one of the vehicles temporarily evacuates outside the lane, so that the vehicle 1 and the other vehicle can travel in the respective traveling directions as a result. The “lane” is not necessarily limited to a paved roadway, and may be any road on which the vehicle 1 can travel.

As illustrated in FIG. 2, the passing assistance unit 170 includes the storage unit 171, an acquisition module 172a, a generation module 172b, a determination module 172c, a search module 172d, an estimation module 172e, a decision module 172f, an output control module 172g, and a reception module 172h.

The storage unit 171 stores the vehicle information 171a, vehicle sensor information 171b, surrounding image information 171c, empty space information 171d, and other vehicle information 171e.

The vehicle information 171a is information related to the size of the vehicle body 12 of the vehicle 1. More specifically, the vehicle information 171a includes a vehicle width and a vehicle length of the vehicle 1.

The vehicle sensor information 171b is a detection result of an obstacle or the like around the vehicle 1 by the wave transmitter/receiver 15.

The surrounding image information 171c is an image around the vehicle 1 captured by the image capturing device 16. In the present embodiment, the surrounding image information 171c is an image of the left and right sides of the vehicle 1 captured along the traveling trajectory of the vehicle 1. Note that the surrounding image information 171c may be included in the vehicle sensor information 171b.

The empty space information 171d is information on a first evacuation candidate area around the traveling trajectory of the vehicle 1. Further, the empty space information 171d is generated from the vehicle sensor information 171b and the surrounding image information 171c by the generation module 172b to be described later.

Note that the empty space information 171d is an example of information indicating the state around the vehicle 1 detected along the traveling trajectory of the vehicle 1 in the present embodiment, but the vehicle sensor information 171b or the surrounding image information 171c may be an example of information indicating the state around the vehicle 1 detected along the traveling trajectory of the vehicle 1. Note that vehicle sensor information 171b and the surrounding image information 171c may be used as the empty space information 171d.

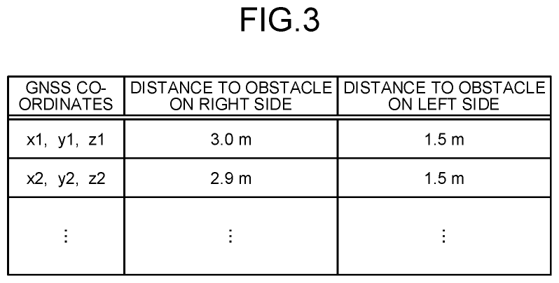

FIG. 3 is a diagram illustrating an example of the empty space information 171d according to the first embodiment. As illustrated in FIG. 1, the vehicle sensor information 171b is associated with, for example, GNSS coordinates, a distance from the vehicle 1 to the right obstacle, and a distance from the vehicle 1 to the left obstacle. Note that the empty space information 171d may further include other information. Further, as the empty space information 171d, not only the distance to the left and right obstacles of the vehicle 1 but also information indicating the position of an empty space having a prescribed size or more may be directly registered.

Although the GNSS coordinates of the vehicle 1 are illustrated as the position information of the vehicle 1 in FIG. 3, the position of the vehicle 1 may be defined by position coordinates of a reference point and a distance the vehicle 1 has moved from the reference point.

In the present embodiment, the other vehicle information 171e is information on the size of the vehicle body of the other vehicle received by the wireless communication unit 110. More specifically, the other vehicle information 171e includes a vehicle width and a vehicle length of the other vehicle.

The storage unit 171 is implemented by, for example, a writable storage medium such as a random access memory (RAM), a flash memory, or a hard disk drive (HDD). Note that, although one storage unit 171 is illustrated in FIG. 2, the same may be implemented by a plurality of storage media. For example, each piece of information may be stored in different storage media.

The acquisition module 172a acquires, from the sensor interface 160, an image around the vehicle 1 and a distance to an object around the vehicle 1 based on a transmission-and-reception result of a sound wave or an electromagnetic wave by the wave transmitter/receiver 15. The acquisition module 172a stores the image around the vehicle 1 acquired from the sensor interface 160 in the storage unit 171. In addition, the acquisition module 172a stores, in the storage unit 171, the distance to the object around the vehicle 1 based on the transmission-and-reception result of the sound wave or the electromagnetic wave by the wave transmitter/receiver 15 acquired from the sensor interface 160 as the vehicle sensor information 171b.

In addition, the acquisition module 172a acquires information indicating the state of the vehicle 1, such as the position and the speed of the vehicle 1 from the vehicle state specification module 150. The acquisition module 172a stores the acquired information indicating the state of the vehicle 1 in the storage unit 171 as the vehicle information 171a.

In addition, the acquisition module 172a stores, in the storage unit 171, the information on the size of the vehicle body of the other vehicle received by the wireless communication unit 110 from the communication message analysis module 120 as the other vehicle information 171e.

In the present embodiment, when it is determined that there is a possibility that passing between the vehicle 1 and the other vehicle occurs, the acquisition module 172a stores the image around the vehicle 1 and the distance to the object around the vehicle 1 in the storage unit 171.

The case in which the passing between the vehicle 1 and the other vehicle may occur is, for example, a case in which a road on which the vehicle 1 travels is narrower than a prescribed width. Note that the acquisition module 172a may measure a width of a road from the image around the vehicle 1 or the distance to an object around the vehicle 1, or may estimate that a road on which the vehicle 1 travels is narrower than a prescribed width when the speed of the vehicle 1 is equal to or less than a prescribed threshold. Note that the acquisition module 172a may store the image around the vehicle 1 and the distance to the object around the vehicle 1 in the storage unit 171 regardless of whether there is a possibility that the passing between the vehicle 1 and the other vehicle occurs.

While the vehicle 1 is traveling, the acquisition module 172a and the generation module 172b collect, as a position of the first evacuation candidate area, a position of an empty space existing around the traveling trajectory of the vehicle 1 and having a prescribed size or more based on the state around the traveling trajectory of the vehicle 1 detected by the wave transmitter/receiver 15 or the image capturing device 16, and store the collected position in the storage unit 171.

The first evacuation candidate area is an area to which the vehicle 1 can evacuate when the passing between the vehicle 1 and the other vehicle occurs. Note that there may be a plurality of first evacuation areas.

More specifically, the generation module 172b generates the empty space information 171d based on the position information of the vehicle 1 acquired by the acquisition module 172a, the image around the vehicle 1, and the distance to the object around the vehicle 1. For example, during traveling of the vehicle 1, the generation module 172b extracts, as the first evacuation candidate area, an empty space existing around the traveling trajectory of the vehicle 1 and having a prescribed size or more based on the state around the traveling trajectory of the vehicle 1 detected by the wave transmitter/receiver 15 or the image capturing device 16, and stores the extracted empty space in the storage unit 171.

As described with reference to FIG. 3, in the empty space information 171d, the position information of the vehicle 1 is associated with the distance between the left and right obstacles and the vehicle 1, so that the position of the empty space having no obstacle can be specified.

Note that, in addition to the result of measuring the distance to the obstacle using the wave transmitter/receiver 15, the generation module 172b may detect an object that hinders traveling of the vehicle 1, such as a step, a curbstone, or a side groove, from the image captured by the image capturing device 16, and may add the detected object as an obstacle. For example, even if a distance between the vehicle 1 and the building is 5 m, when a distance between the vehicle 1 and a step that the vehicle 1 cannot pass is 1 m, the generation module 172b may set a distance between the vehicle 1 and the obstacle to 1 m and register the distance as the empty space information 171d.

Further, in the present embodiment, the generation module 172b generates the empty space information 171d when the acquisition module 172a determines that there is a possibility that the passing between the vehicle 1 and the other vehicle occurs. Note that the generation module 172b may generate the empty space information 171d regardless of whether there is a possibility that the passing between the vehicle 1 and the other vehicle occurs.

Note that, although the empty space information 171d is generated by the generation module 172b in the present embodiment, a result of measuring a distance to an object around the vehicle 1 by the wave transmitter/receiver 15 or an image around the vehicle 1 captured by the image capturing device 16 may be used as the empty space information 171d.

The determination module 172c determines whether the vehicle 1 can pass the other vehicle based on the state around the vehicle 1, the information on the size of the vehicle body of the other vehicle, and the size of the vehicle body 12 of the vehicle 1.

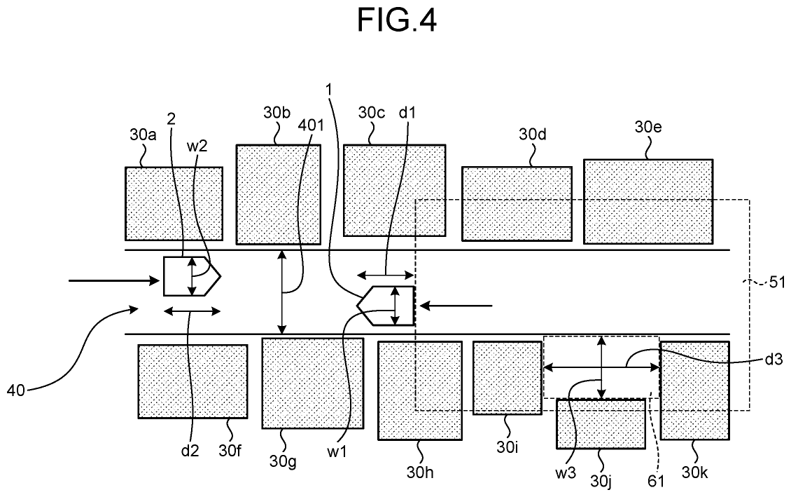

Here, the passing between the vehicle 1 and the other vehicle will be described with reference to FIG. 4. FIG. 4 is a diagram illustrating an example of a positional relationship between the vehicle 1 and the other vehicle 2 according to the first embodiment.

The vehicle 1 travels on a road 40 from the right side to the left side in FIG. 4. It is assumed that the road 40 illustrated in FIG. 4 is a one-lane road, and a length 401 of the road 40 in the width direction is equal to or less than a predetermined threshold. There are obstacles 30a to 30k such as buildings on the opposite sides of the road 40. Hereinafter, the individual obstacles 30a to 30k will be simply referred to as an obstacle 30 unless otherwise distinguished.

A first area 51 illustrated in FIG. 4 is an area in which empty space information has been acquired along the traveling trajectory of the vehicle 1. The first area 51 is a range detected by the wave transmitter/receiver 15 of the vehicle 1 or an area captured by the image capturing device 16, and the same is formed along the traveling trajectory of the vehicle 1. Further, the empty space information 171d is stored in the storage unit 171.

The determination module 172c determines whether the passing between the vehicle 1 and the other vehicle 2 occurs. When determining that the passing between the vehicle 1 and the other vehicle 2 has occurred, the determination module 172c determines whether the vehicle 1 and the other vehicle 2 cannot move forwards and cannot pass each other.

For example, the determination module 172c determines that the passing between the vehicle 1 and the other vehicle 2 occurs when the wireless communication unit 110 receives the other vehicle information 171e on the other vehicle 2 from the other vehicle 2, the other vehicle 2 is traveling in the same lane as the vehicle 1, and the traveling direction of the other vehicle 2 faces the traveling direction of the vehicle 1. When the wireless communication unit 110 receives the other vehicle information 171e by V2X communication or the like, a distance between the vehicle 1 and the other vehicle 2 is equal to or less than a communication distance. Note that the determination module 172c may execute determination processing in a case where the other vehicle 2 traveling from the front of the vehicle 1 is detected based on the detection result of the wave transmitter/receiver 15f, the first image capturing device 16a, or the like.

The determination module 172c determines whether the other vehicle 2 is traveling in the same lane as the vehicle 1 based on, for example, a distance and a positional relationship between the other vehicle 2 and the vehicle 1 measured by the wave transmitter/receiver 15f, or an image ahead of the vehicle 1, the image being captured by the first image capturing device 16a. Note that a method of determining whether the passing therebetween occurs is not limited thereto, and a known method may be adopted.

The example illustrated in FIG. 4 shows a state in which the other vehicle 2 is traveling in the same lane as the vehicle 1, and the passing between the vehicle 1 and the other vehicle 2 occurs. The other vehicle information 171e includes a vehicle width w2 and a vehicle length d2 of the other vehicle 2.

As in the example illustrated in FIG. 4, when the other vehicle 2 is traveling in the same lane as the vehicle 1 and the traveling direction of the other vehicle 2 faces the traveling direction of the vehicle 1, the determination module 172c determines whether the vehicle 1 and the other vehicle 2 cannot move forwards and cannot pass each other.

More specifically, the determination module 172c determines whether the vehicle 1 and the other vehicle 2 can move forwards and pass each other based on the width 401 of the road 40 on which the vehicle 1 travels, a width w1 of the vehicle body 12 of the vehicle 1 included in the vehicle information 171a, the width w2 of the vehicle body of the other vehicle 2 included in the other vehicle information 171e, and a prescribed buffer distance in the vehicle width direction.

The prescribed buffer distance in the vehicle width direction is the sum of a lower limit value of a distance in the vehicle width direction between the vehicle 1 and the other vehicle 2 and a lower limit value of a distance between left and right obstacles of the vehicle 1 and the other vehicle 2 when the vehicle 1 and the other vehicle 2 pass each other. The distance between the vehicle 1 and the other vehicle 2 in the vehicle width direction, that is, the lower limit value of the inter-vehicle distance in the vehicle width direction may be set in advance to a prescribed value, or the same may be set by a user. In addition, the prescribed value may be set in advance for the lower limit value of the distance between the left and right obstacles of the vehicle 1 and the other vehicle 2, or the same may be set by the user.

When the width 401 of the road 40 on which the vehicle 1 travels is equal to or greater than the sum of the width w1 of the vehicle body 12 of the vehicle 1, the width w2 of the vehicle body of the other vehicle 2, and the prescribed buffer distance in the vehicle width direction, the determination module 172c determines that the vehicle 1 and the other vehicle 2 can move forwards and pass each other on the road 40. When the width 401 of the road 40 is less than the sum of the width w1 of the vehicle body 12 of the vehicle 1, the width w2 of the other vehicle 2, and the prescribed buffer distance, the determination module 172c determines that the vehicle 1 and the other vehicle 2 cannot move forwards and cannot pass each other.

For example, since the length of the width 401 of the road 40 necessary for the passing therebetween varies depending on the sizes of the vehicle bodies of the vehicle 1 and the other vehicle 2, there are other vehicles including a vehicle capable of passing the vehicle 1 and a vehicle not capable of passing the vehicle 1 even if the passing between the vehicle 1 and the other vehicle 2 occurs on the same road 40. By using the width w1 of the vehicle body 12 of the vehicle 1 and the width w2 of the vehicle body of the other vehicle 2 included in the other vehicle information 171e for determination, the determination module 172c can determine whether the passing therebetween can be performed depending on the other vehicle 2 which is an actual passing target.

Note that the width 401 of the road 40 may be a width including a range in which the vehicle 1 or the other vehicle 2 can travel, such as a road shoulder of the road 40.

In the example illustrated in FIG. 4, the width 401 of the road 40 on which the vehicle 1 travels is assumed to be less than a value obtained by summing the width w1 of the vehicle body 12 of the vehicle 1, the width w2 of the vehicle body of the other vehicle 2, and the prescribed buffer distance in the vehicle width direction.

In a case where it is determined that the passing between the vehicle 1 and the other vehicle 2 cannot be performed, the search module 172d searches for a first evacuation candidate area 61 to which the vehicle 1 can evacuate based on the state around the vehicle 1, the state being detected along the traveling trajectory of the vehicle 1 by the wave transmitter/receiver 15 or the image capturing device 16.

In the present embodiment, the search module 172d searches for the first evacuation candidate area 61 based on the empty space information 171d stored in the storage unit 171.

The first evacuation candidate area 61 exists around the traveling trajectory of the vehicle 1 and is a place to which the vehicle 1 can evacuate. Since the vehicle 1 travels from the rear toward the front, the first evacuation candidate area 61 is located behind the vehicle 1. In the example illustrated in FIG. 4, one first evacuation candidate area 61 exists behind the vehicle 1.

The first evacuation candidate area is an area in which a width w3 and a length d3 are equal to or greater than a prescribed length. Note that the prescribed lengths of the width w3 and the length d3 of the first evacuation candidate area vary depending on the width w1 and the length d1 of the vehicle body 12 of the vehicle 1. Note that the first evacuation candidate area is not necessarily larger than the vehicle body 12 of the vehicle 1 as long as a part of the vehicle body 12 of the vehicle 1 can evacuate thereto.

Note that, in a case where there are a plurality of places satisfying conditions, the search module 172d may specify a plurality of first evacuation candidate areas 61.

The estimation module 172e estimates a passing point between the vehicle 1 and the other vehicle 2, the passing point being located behind the vehicle 1, based on the search result of the first evacuation candidate area 61 by the search module 172d. More specifically, when the determination module 172c determines that the vehicle 1 and the other vehicle 2 cannot move forwards and cannot pass each other, the estimation module 172e estimates a passing point at which the vehicle 1 and the other vehicle 2 can pass each other by allowing the vehicle 1 to evacuate to the first evacuation candidate area 61 to which the vehicle 1 can evacuate.

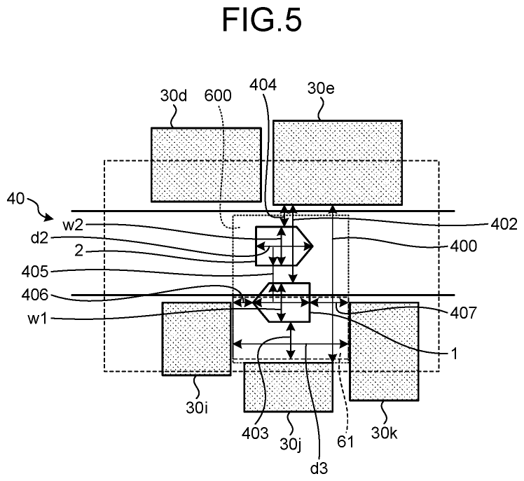

FIG. 5 is a diagram illustrating an example of a passing point 600 according to the first embodiment. When there is a section in which the sum of a distance 402 from the vehicle 1 to the obstacle 30e on the right side of the vehicle 1 and a distance 403 from the vehicle 1 to the obstacle 30j on the left side of the vehicle 1 is equal to or greater than the sum of the vehicle width w2 of the other vehicle 2 and the prescribed buffer distance in the vehicle width direction, and the length d3 of the section is equal to or greater than the sum of the vehicle length d1 of the vehicle 1 and the prescribed buffer distance in the vehicle length direction, the estimation module 172e determines the section as the passing point 600.

The prescribed buffer distance in the vehicle width direction is, for example, a distance obtained by adding the lower limit value of the inter-vehicle distance in the vehicle width direction and the lower limit value of the distance of the vehicle 1 and the other vehicle 2 from the left and right obstacles 30, the distance being used in determining, by the determination module 172c, whether the passing therebetween can be performed. The prescribed buffer distance in the vehicle length direction may be set in advance or may be set by a user. The prescribed buffer distance in the vehicle length direction is, for example, a length in the vehicle length direction of a movement space to be used when the vehicle 1 enters and exits from the first evacuation candidate area 61.

In the example illustrated in FIG. 5, when the vehicle 1 has evacuated to the first evacuation candidate area 61, the distance 402 from the vehicle 1 to the obstacle 30e on the right side of the vehicle 1 and the distance 403 from the vehicle 1 to the obstacle 30j on the left side of the vehicle 1 are equal to or greater than the sum of the vehicle width w2 of the other vehicle 2 and the prescribed buffer distance in the vehicle width direction. In addition, the length d3 of the first evacuation candidate area 61 is equal to or greater than the sum of the vehicle length d1 of the vehicle 1 and the prescribed buffer distance in the vehicle length direction. Therefore, when the vehicle 1 evacuates to the first evacuation candidate area 61, sufficient distances 406 and 407 respectively between the vehicle 1 and the obstacle 30i and between the vehicle 1 and the obstacle 30k can be secured in front of and behind the vehicle 1.

That is, a distance 400 from the obstacle 30e to the obstacle 30j can secure a distance 404 between the other vehicle 2 and the obstacle 30e, a distance 405 between the vehicle 1 and the other vehicle 2, and the distance 403 between the vehicle 1 and the obstacle 30j so as to be respectively equal to or greater than prescribed distances. Accordingly, when the vehicle 1 and the other vehicle 2 pass each other in a state where the vehicle 1 evacuates to the first evacuation candidate area 61, it is possible to secure a distance that enables the vehicle 1 and the other vehicle 2 not to contact each other in the width direction.

When there are a plurality of first evacuation candidate areas 61, the estimation module 172e may estimate whether the vehicle 1 and the other vehicle 2 can pass each other in each of the plurality of first evacuation candidate areas 61, and may determine, as an evacuation destination, one first evacuation candidate area closest to the current position of the vehicle 1 among the plurality of first evacuation candidate areas 61 where the vehicle 1 and the other vehicle 2 can pass each other.

Referring back to FIG. 2, the decision module 172f decides a support content based on a determination result by the determination module 172c as to whether passing in front of the vehicle 1 is performable and an estimation result by the estimation module 172e as to a passing point. For example, the decision module 172f decides presence or absence of notification of the first evacuation candidate area 61 to a driver and a notification content. In addition, for example, the decision module 172f decides a movement route for the vehicle 1 to move to the first evacuation candidate area 61 serving as an evacuation destination of the vehicle 1 when the vehicle 1 passes the other vehicle 2 at the passing point 600 estimated by the estimation module 172e.

The output control module 172g causes the display 17 to display the search result of the first evacuation candidate area 61. For example, when the decision module 172f decides to notify a driver of the first evacuation candidate area 61, the output control module 172g causes the display 17 to display the first evacuation candidate area 61 serving as an evacuation destination of the vehicle 1 when the vehicle 1 passes the other vehicle 2 at the passing point 600 estimated by the estimation module 172e, and the movement route of the vehicle 1 to the first evacuation candidate area 61.

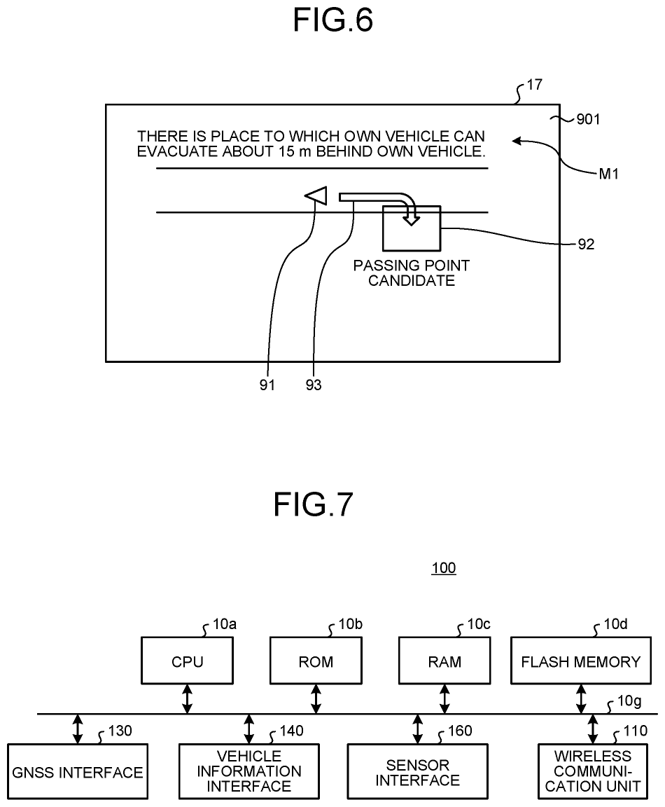

FIG. 6 is a diagram illustrating an example of an evacuation destination guidance screen 901 displayed on the display 17 according to the first embodiment. As illustrated in FIG. 6, the output control module 172g causes the display 17 to display the evacuation destination guidance screen 901 including a message M1 for explaining the position of the first evacuation candidate area 61, a first image 91 indicating the current position of the vehicle 1, a second image 92 indicating the position of the first evacuation candidate area 61, and a third image 93 indicating a movement route from the current position of the vehicle 1 to the first evacuation candidate area 61.

Note that a means for guiding a driver to an evacuation destination is not limited to a display on the display 17. For example, the output control module 172g may cause the speaker 18 to output a voice message for explaining the position of the first evacuation candidate area 61.

In addition, the output control module 172g causes the display 17 to display an operation screen on which a user can input the start of movement of the vehicle 1 to the first evacuation candidate area 61 by automatic driving. Note that the evacuation destination guidance screen 901 may also serve as the operation screen. In the present embodiment, a driver or a passenger of the vehicle 1 is the user.

Referring back to FIG. 2, the reception module 172h receives an operation by the user via the operation unit 19. For example, the reception module 172h receives, from the user, an input of a lower limit value of an inter-vehicle distance in the vehicle width direction, an input of a lower limit value of a distance between the left and right obstacles of the vehicle 1 and the other vehicle 2, and an input of a prescribed buffer distance in the vehicle length direction.

In addition, the reception module 172h receives, from the user, an operation of starting movement of the vehicle 1 to the first evacuation candidate area 61 by automatic driving. When receiving the start operation, the reception module 172h sends the reception of the start operation of the automatic driving to the vehicle control module 190. Furthermore, in this case, the vehicle control module 190 acquires the movement route of the vehicle 1 decided by the decision module 172f from the passing assistance unit 170. Note that the vehicle control module 190 may decide the movement route of the vehicle 1.

Next, a hardware configuration of the driving assistance device 100 will be described. FIG. 7 is a diagram illustrating an example of the hardware configuration of the driving assistance device 100 according to the first embodiment. As illustrated in FIG. 7, in the driving assistance device 100, for example, a central processing unit (CPU) 10a, a read only memory (ROM) 10b, a RAM 10c, a flash memory 10d, the GNSS interface 130, the vehicle information interface 140, the sensor interface 160, the wireless communication unit 110, and the like are mutually connected to each other by a bus 10g, and the hardware configuration of the driving assistance device 100 is achieved by using a normal computer.

The CPU 10a is an arithmetic device that controls the overall driving assistance device 100. The ROM 10b stores a program and the like for implementing various types of processing by the CPU 10a. The RAM 10c and the flash memory 10d store data necessary for various types of processing by the CPU 10a. The driving assistance device 100 may include a hard disk drive (HDD). The CPU 10a of the driving assistance device 100 executes the program stored in the ROM 10b, thereby executing the functions of the communication message analysis module 120, the vehicle state specification module 150, the sensor interface 160, the communication message generation module 180, the vehicle control module 190, and the passing assistance unit 170 including various units such as the acquisition module 172a, the generation module 172b, the determination module 172c, the search module 172d, the estimation module 172e, the decision module 172f, the output control module 172g, and the reception module 172h described in FIG. 2. Furthermore, the storage unit 171 of the passing assistance unit 170 is implemented by, for example, the RAM 10c or the flash memory 10d.

The program executed by the driving assistance device 100 according to the present embodiment may be provided by being recorded in a computer-readable recording medium such as a CD-ROM, a flexible disk (FD), a CD-R, or a digital versatile disk (DVD) as a file in an installable format or an executable format. Furthermore, the program executed by the driving assistance device 100 of the present embodiment may be configured to be stored in a computer connected to a network such as the Internet and provided by being downloaded via the network. In addition, the program executed by the driving assistance device 100 of the present embodiment may be provided or distributed via a network such as the Internet.

Although one CPU 10a and one ROM 10b are provided in FIG. 7, the functional units included in the driving assistance device 100 may be implemented by separate CPUs 10a and ROMs 10b. For example, the communication message analysis module 120, the vehicle state specification module 150, the vehicle control module 190, the communication message generation module 180, and the passing assistance unit 170 may be implemented by different computers. Although the vehicle control module 190 is included in the driving assistance device 100 in FIG. 2 described above, the vehicle control module 190 may be provided as an individual device outside the driving assistance device 100.

Next, a description will be given as to a flow of passing assistance processing executed by the driving assistance device 100 configured as described above.

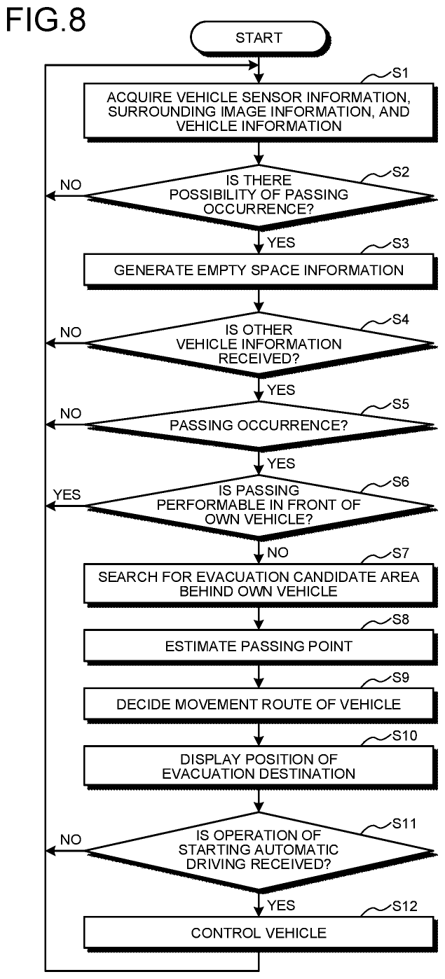

FIG. 8 is a flowchart illustrating an example of a flow of the passing assistance processing according to the first embodiment. The processing of this flowchart starts, for example, when the vehicle 1 starts traveling.

First, the acquisition module 172a acquires, from the sensor interface 160, the vehicle sensor information 171b and the surrounding image information 171c related to the state around the vehicle 1. The acquisition module 172a acquires the vehicle information 171a from the vehicle state specification module 150 (S1).

The acquisition module 172a determines whether there is a possibility that passing between the vehicle 1 and the other vehicle occurs based on the acquired vehicle sensor information 171b and surrounding image information 171c (S2). For example, when the road on which the vehicle 1 is traveling is wider than a prescribed width or is a road with two or more lanes, the acquisition module 172a determines that there is no possibility that the passing between the vehicle 1 and the other vehicle occurs (S2 “No”). In this case, the processing returns to S1.

In addition, for example, in a case where the road on which the vehicle 1 travels is one lane narrower than the prescribed width, the acquisition module 172a determines that there is a possibility that the passing between the vehicle 1 and the other vehicle occurs (S2 “Yes”). In this case, the acquisition module 172a stores the acquired vehicle information 171a, vehicle sensor information 171b, and surrounding image information 171c in the storage unit 171.

In this case, the generation module 172b generates the empty space information 171d based on the vehicle information 171a, the vehicle sensor information 171b, and the surrounding image information 171c, and stores the empty space information 171d in the storage unit 171 (S3).

When the wireless communication unit 110 receives the other vehicle information 171e also during the start of processing of this flowchart, the acquisition module 172a acquires the other vehicle information 171e and stores the same in the storage unit 171. The determination module 172c determines whether the other vehicle information 171e has been received (S4). When the wireless communication unit 110 has not received the other vehicle information 171e (S4 “No”), the processing returns to S1.

When the wireless communication unit 110 receives the other vehicle information 171e (S4 “Yes”), the determination module 172c determines whether the passing between the vehicle 1 and the other vehicle 2 occurs (S5). For example, when the traveling direction of the other vehicle 2 in front of the vehicle 1 is the same as the traveling direction of the vehicle 1, the determination module 172c determines that the passing between the vehicle 1 and the other vehicle 2 does not occur (S5 “No”). In this case, the processing returns to S1.

For example, when the other vehicle 2 is traveling in the same lane as the vehicle 1 and the traveling direction of the other vehicle 2 faces the traveling direction of the vehicle 1, the determination module 172c determines that the passing between the vehicle 1 and the other vehicle 2 occurs (S5 “Yes”).

In this case, the determination module 172c determines whether the vehicle 1 and the other vehicle 2 can pass each other in front of the vehicle 1 (S6). For example, when the width 401 of the road 40 on which the vehicle 1 travels is equal to or greater than the sum of the width w1 of the vehicle body 12 of the vehicle 1, the width w2 of the vehicle body of the other vehicle 2, and the prescribed buffer distance in the vehicle width direction, the determination module 172c determines that the vehicle 1 and the other vehicle 2 can move forwards and pass each other on the road 40 (S6 “Yes”). In this case, the vehicle 1 and the other vehicle 2 can pass each other as a driver continues driving the vehicle 1 forwards. When the determination module 172c determines that the vehicle 1 and the other vehicle 2 can pass each other in front of the vehicle 1, the processing returns to S1. Note that, in this case, the output control module 172g may cause the display 17 to display that the vehicle 1 and the other vehicle 2 can pass each other in front of the vehicle 1, or may cause the speaker 18 to issue a notification.

In addition, for example, in a case where the width 401 of the road 40 is less than the sum of the width w1 of the vehicle body 12 of the vehicle 1, the width w2 of the other vehicle 2, and the prescribed buffer distance, the determination module 172c determines that the vehicle 1 and the other vehicle 2 cannot pass each other in front of the vehicle 1 when the two vehicles move forwards with each other (S6 “No”). In this case, the search module 172d searches for an evacuation candidate area behind the vehicle 1, that is, the first evacuation candidate area 61 (S7).

Then, the estimation module 172e estimates the passing point 600 based on the searched first evacuation candidate area 61 (S8).

Next, the decision module 172f decides a movement route of the vehicle 1 to the first evacuation candidate area 61 so as to move the vehicle 1 up to a parking position at which the vehicle 1 and the other vehicle 2 can pass each other at the estimated passing point 600 (S9).

Then, the output control module 172g displays the position of an evacuation destination on the display 17 (S10). For example, when the decision module 172f decides to notify a driver of the first evacuation candidate area 61, the output control module 172g causes the display 17 to display the first evacuation candidate area 61 serving as an evacuation destination of the vehicle 1 when the vehicle 1 passes the other vehicle 2 at the passing point 600 estimated by the estimation module 172e, and the movement route of the vehicle 1 to the first evacuation candidate area 61.

Then, the reception module 172h determines whether an operation of starting the automatic driving to the evacuation destination by a user has been received (S11). When the reception module 172h does not receive the operation of starting the automatic driving to the evacuation destination by the user (S11 “No”), for example, when the driver moves the vehicle 1 to the evacuation destination by manual driving, the processing returns to S1.

When the reception module 172h receives the operation of starting the automatic driving to the evacuation destination by the user (S11 “Yes”), the vehicle control module 190 moves the vehicle 1 to the evacuation destination by the automatic driving (S12). Thereafter, the processing returns to the processing in S1, and the processing of this flowchart is continuously executed while the vehicle 1 is traveling.

As described above, the vehicle 1 of the present embodiment includes the wave transmitter/receiver 15 or the image capturing device 16 capable of detecting the surrounding state, and the wireless communication unit 110 capable of receiving, from the other vehicle 2, the other vehicle information 171e related to the other vehicle 2, and the other vehicle information 171e includes information related to the size of the vehicle body of the other vehicle 2. In addition, when determining that passing between the vehicle 1 and the other vehicle 2 is not possible, the vehicle 1 of the present embodiment searches for the first evacuation candidate area 61 to which the vehicle 1 can evacuate based on the state around the vehicle 1 detected along the traveling trajectory of the vehicle 1 by the wave transmitter/receiver 15 or the image capturing device 16, and displays the search result of the first evacuation candidate area 61 on the display 17. Therefore, with the vehicle 1 of the present embodiment, when it is difficult to perform the passing between the vehicle 1 and the other vehicle 2 which is an oncoming vehicle, it is possible to present an appropriate evacuation place depending on the actual road situation.

For example, in the periphery of the road 40, there may be various objects that may be obstacles to the evacuation of the vehicle 1 other than an object existing without long-term movement such as a building. Therefore, when the passing point is estimated based on static information such as a map database, it may be difficult to appropriately specify an evacuation place in accordance with the current road situation. On the other hand, the evacuation destination of the vehicle 1 is selected based on the state around the vehicle 1 detected along the traveling trajectory of the vehicle 1 by the wave transmitter/receiver 15 or the image capturing device 16 as in the present embodiment, thereby making it possible to provide a driver of the vehicle 1 with assistance in accordance with the situation.

In addition, when the other vehicle 2 is traveling in the same lane as the vehicle 1 and the traveling direction of the other vehicle 2 faces the traveling direction of the vehicle 1, the vehicle 1 of the present embodiment determines whether the vehicle 1 and the other vehicle 2 cannot move forwards and cannot pass each other. In addition, when determining that the vehicle 1 and the other vehicle 2 cannot move forwards and cannot pass each other, the vehicle 1 of the present embodiment estimates the passing point 600 at which the vehicle 1 can pass the other vehicle 2 by evacuating to the first evacuation candidate area 61 to which the vehicle 1 can evacuate, and displays, on the display 17, the movement route up to the first evacuation candidate area 61 specified as an evacuation destination configured to enable the vehicle 1 and the other vehicle 2 to pass each other at the passing point 600. Generally, it is not difficult for the vehicle 1 to move forwards and pass the other vehicle 2, but it is difficult for the vehicle 1 to pass the other vehicle 2 by evacuating to an appropriate evacuation place located behind the vehicle 1. With the vehicle 1 of the present embodiment, it is possible to provide appropriate assistance depending on the situation to a driver of the vehicle 1 in a case where the vehicle 1 evacuates rearwards in order to perform the passing with the other vehicle 2.

In addition, when it is determined that the vehicle 1 and the other vehicle 2 cannot move forwards and cannot pass each other, the vehicle 1 of the present embodiment moves to the first evacuation candidate area 61 by automatic driving. Generally, driving the vehicle 1 so as to evacuate to the first evacuation candidate area 61 located behind the vehicle 1 is more difficult than passing the other vehicle 2 in front of the vehicle 1, which may be difficult situation to a driver or may take time for driving depending on the skill of the driver. With the vehicle 1 of the present embodiment, it is possible to quickly move the vehicle 1 to an appropriate position even when the vehicle 1 evacuates rearwards.

In addition, during traveling, the vehicle 1 according to the present embodiment collects, as a position of the first evacuation candidate area 61, a position of an empty space, existing around the traveling trajectory of the vehicle 1 and having a prescribed size or more, based on the state around the traveling trajectory of the vehicle 1 detected by the wave transmitter/receiver 15 or the image capturing device 16, and stores the collected position in the storage unit 171. Therefore, with the vehicle 1 of the present embodiment, before the passing between the vehicle 1 and the other vehicle 2 occurs, it is possible to specify the first evacuation candidate area 61 behind the vehicle 1 to which the vehicle 1 can evacuate when the passing therebetween occurs. When the evacuation destination of the vehicle 1 is searched for after the vehicle 1 approaches the other vehicle 2, it may be difficult to search for an empty space behind the vehicle 1. By grasping the position of the empty space while the vehicle 1 is traveling, it is possible to easily specify the evacuation place of the vehicle 1 when the passing therebetween occurs in the actual situation.

In addition, the vehicle 1 of the present embodiment determines whether the vehicle 1 and the other vehicle 2 can move forwards and pass each other based on the width 401 of the road 40 on which the vehicle 1 travels, the width w1 of the vehicle body 12 of the vehicle 1 included in the vehicle information 171a, the width w2 of the vehicle body of the other vehicle 2 included in the other vehicle information 171e, and the prescribed buffer distance in the vehicle width direction. The prescribed buffer distance in the vehicle width direction is the sum of the lower limit value of the distance in the vehicle width direction between the vehicle 1 and the other vehicle 2 and the lower limit value of the distance between the left and right obstacles of the vehicle 1 and the other vehicle 2 when the vehicle 1 and the other vehicle 2 pass each other. In addition, when the width 401 of the road 40 is less than the sum of the width w1 of the vehicle body 12 of the vehicle 1, the width w2 of the other vehicle 2, and the prescribed buffer distance, the vehicle 1 of the present embodiment determines that the vehicle 1 and the other vehicle 2 cannot move forwards and cannot pass each other. Therefore, with the vehicle 1 of the present embodiment, in consideration of the sizes of the vehicle 1 and the other vehicle 2, it is possible to determine with high accuracy whether the vehicle 1 and the other vehicle 2 can move forwards and pass each other without contacting the surrounding obstacle 30 and the vehicle bodies of each other.

### Second Embodiment

In a second embodiment, the vehicle 1 specifies an evacuation place behind the vehicle 1 or the other vehicle 2 by performing arbitration with the other vehicle 2.

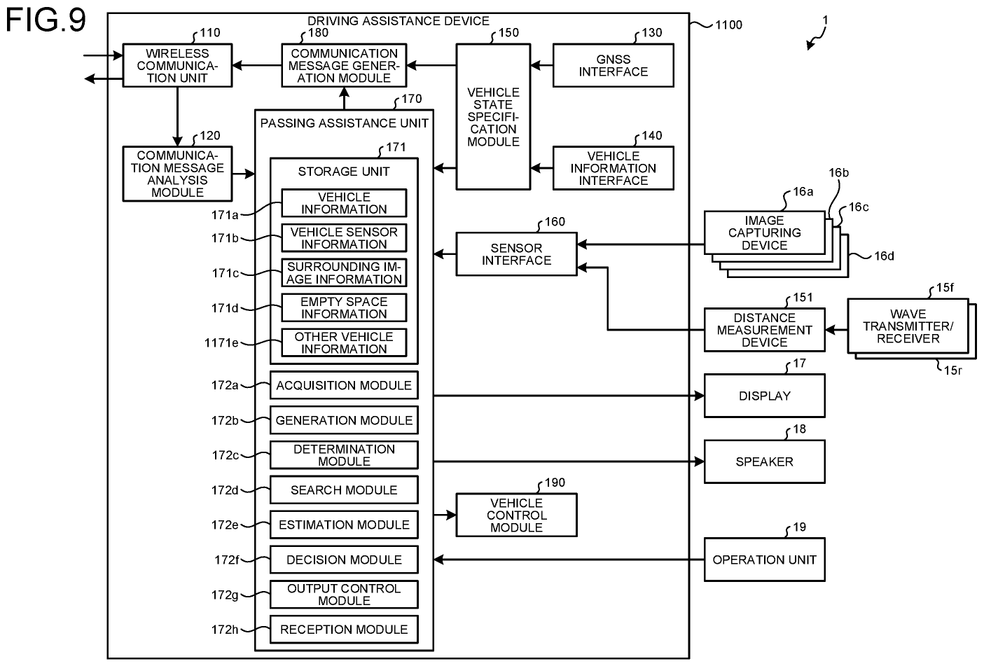

FIG. 9 is a block diagram illustrating an example of a configuration of a driving assistance device 1100 according to the second embodiment. As in the first embodiment, the driving assistance device 1100 mounted on the vehicle 1 of the present embodiment includes a wireless communication unit 110, a communication message analysis module 120, a GNSS interface 130, a vehicle information interface 140, a vehicle state specification module 150, a sensor interface 160, a passing assistance unit 170, a communication message generation module 180, and a vehicle control module 190.

The wireless communication unit 110 of the present embodiment receives the vehicle width w1 and the vehicle length d1 of the other vehicle 2 by V2X communication or the like as in the first embodiment. In addition, the wireless communication unit 110 of the present embodiment further receives, from the other vehicle 2, information on a second evacuation candidate area to which the other vehicle 2 can evacuate, the second evacuation candidate area being located around the travel route of the other vehicle 2. The information is, for example, a measurement result of a distance to the surrounding obstacle 30 by a sonar or a radar of the other vehicle 2, or an image around a traveling trajectory of the other vehicle 2 captured by an image capturing device. In addition, the information may be a history of a distance between the other vehicle 2 and the surrounding obstacle 30 generated based on the measurement result of the distance to the surrounding obstacle by the sonar or the radar and the image around the traveling trajectory of the other vehicle 2.

In addition, the wireless communication unit 110 of the present embodiment can mutually transmit and receive information to and from the other vehicle, and transmits information on an evacuation destination of the vehicle 1 or the other vehicle 2 or a request for evacuation to an evacuation candidate area behind the other vehicle 2 to the other vehicle 2 under the control of the passing assistance unit 170. The evacuation candidate area behind the other vehicle 2 is referred to as a second evacuation candidate area.

Similarly to the first embodiment, the passing assistance unit 170 of the present embodiment includes a storage unit 171, an acquisition module 172a, a generation module 172b, a determination module 172c, a search module 172d, an estimation module 172e, a decision module 172f, an output control module 172g, and a reception module 172h.

In addition, the storage unit 171 of the present embodiment stores vehicle information 171a, vehicle sensor information 171b, surrounding image information 171c, empty space information 171d, and other vehicle information 1171e. The vehicle information 171a, the vehicle sensor information 171b, the surrounding image information 171c, and the empty space information 171d are similar to those in the first embodiment.

The other vehicle information 1171e of the present embodiment includes, in addition to the vehicle width w1 and the vehicle length d1 of the other vehicle 2 described in the first embodiment, information related to the second evacuation candidate area to which the other vehicle 2 can evacuate around the traveling trajectory of the other vehicle 2.

The distinguishment may be made such that the vehicle width w1 and the vehicle length d1 of the other vehicle 2 is included in the other vehicle information, and the information on the second evacuation candidate area to which the other vehicle 2 can evacuate around the traveling trajectory of the other vehicle 2 is included in the other vehicle sensor information.

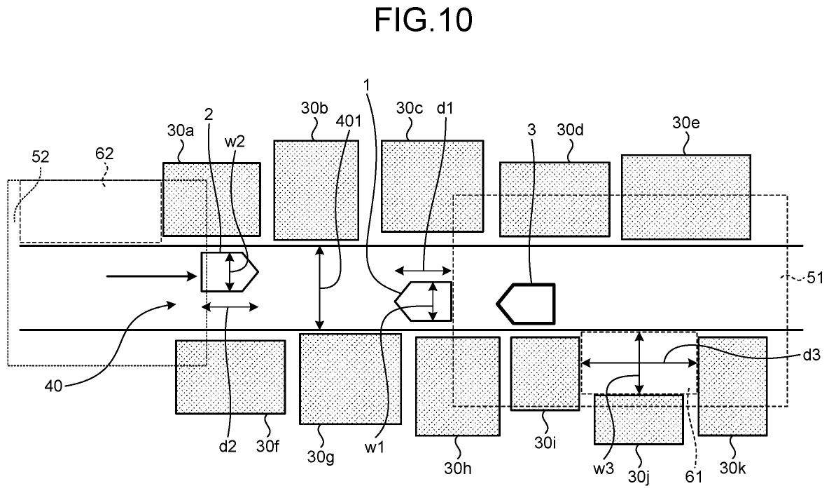

FIG. 10 is a diagram illustrating an example of a positional relationship between the vehicle 1 and the other vehicle 2 according to the second embodiment. A second area 52 along the traveling trajectory of the other vehicle 2 illustrated in FIG. 10 is an area where empty space information has been acquired by the other vehicle 2 along the traveling trajectory of the other vehicle 2.

In the example illustrated in FIG. 10, a second evacuation candidate area 62 to which the other vehicle 2 can evacuate is present in the second area 52.

Referring back to FIG. 9, the search module 172d of the passing assistance unit 170 of the present embodiment has the function of the first embodiment, and searches for an evacuation destination of the vehicle 1 or the other vehicle 2 based on the other vehicle information 1171e and the vehicle sensor information 171b when the determination module 172c determines that the vehicle 1 and the other vehicle 2 cannot move forwards and cannot pass each other. That is, the search module 172d sets not only the first evacuation candidate area 61 behind the vehicle 1 but also the second evacuation candidate area 62 behind the other vehicle 2 as a search target.

In addition, the estimation module 172e of the present embodiment has the function of the first embodiment, and then estimates the passing point 600 based on the searched first evacuation candidate area 61 and second evacuation candidate area 62. That is, the estimation module 172e of the present embodiment estimates the passing point 600 not only in a case where the vehicle 1 evacuates rearwards, but also in a case where the other vehicle 2 evacuates toward the rear side of the other vehicle 2.

In addition, the determination module 172c of the present embodiment has the function of the first embodiment and when it is determined that the vehicle 1 and the other vehicle 2 cannot move forwards and cannot pass each other, the determination module 172c determines a priority of evacuation of the vehicle 1 or the other vehicle 2 based on the state around the vehicle 1, the position and the size of the first evacuation candidate area 61, and the position and the size of the second evacuation candidate area 62.

For example, in the example illustrated in FIG. 10, since the state around the vehicle 1 is a state in which the following vehicle 3 of the vehicle 1 exists behind the vehicle 1, it is difficult for the vehicle 1 to evacuate to the first evacuation candidate area 61. In such a case, the determination module 172c determines that the priority of evacuation of the other vehicle 2 is higher than that of the vehicle 1. It is assumed that the wave transmitter/receiver 15, the image capturing device 16, or the wireless communication unit 110 can detect the following vehicle 3 of the vehicle 1, and the state around the vehicle 1 includes presence or absence of the following vehicle 3 of the vehicle 1.

Note that a method of determining the priority of evacuation of the vehicle 1 and the other vehicle 2 is not limited thereto, and the vehicle 1 and the other vehicle 2 may decide the priority of evacuation by performing arbitration by transmitting and receiving the difficulty of evacuation to and from each other by V2X communication or the like. In the present embodiment, the search module 172d of the vehicle 1 searches for the second evacuation candidate area 62, but the vehicle 1 may acquire a result of searching for the second evacuation candidate area 62 by the other vehicle 2, that is, the position and the size of the second evacuation candidate area 62 by V2X communication or the like.

In addition, the output control module 172g of the present embodiment has the function of the first embodiment, and outputs information on the evacuation destination of the vehicle 1 or the other vehicle 2 searched by the search module 172d to the display 17 and the other vehicle 2.

For example, in a case where the priority of evacuation by the other vehicle 2 is higher than the priority of evacuation by the vehicle 1, the output control module 172g transmits, to the other vehicle 2, a request for evacuation to the second evacuation candidate area 62. More specifically, the output control module 172g sends, to the communication message generation module 180, information on the request for evacuation to the second evacuation candidate area 62 to the other vehicle 2. The communication message generation module 180 generates a message in a format conforming to V2X communication from a content of the request and transmits the message to the wireless communication unit 110. The wireless communication unit 110 transmits the message generated by the communication message generation module 180 to the other vehicle 2.

Note that the transmission of the request for evacuation to the second evacuation candidate area 62 to the other vehicle 2 may be limited to a case in which the other vehicle 2 can receive the message of the evacuation request from the vehicle 1. For example, when the wireless communication unit 110 transmits a communication signal to the other vehicle 2 and a response to the signal is transmitted from the other vehicle 2, the output control module 172g may output the request for evacuation to the second evacuation candidate area 62.

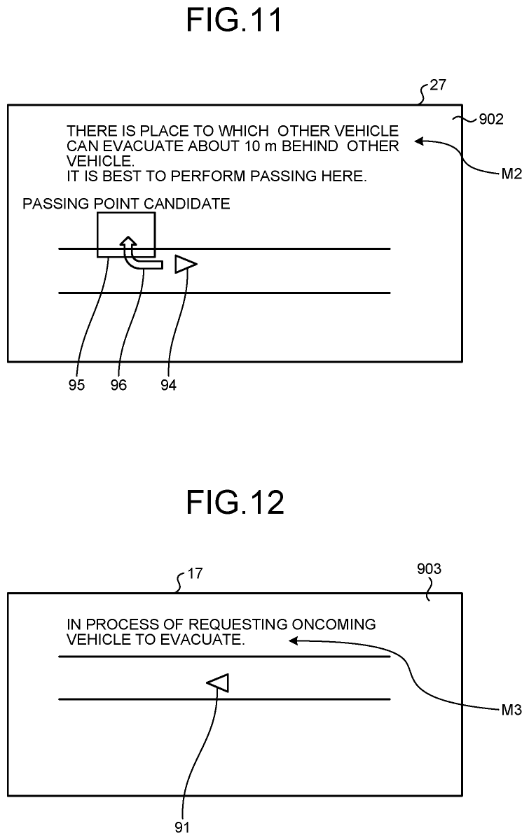

FIG. 11 is a diagram illustrating an example of an evacuation request screen 902 displayed on a display 27 of the other vehicle 2 according to the second embodiment. The other vehicle 2 of the present embodiment may include the driving assistance device 1100 similar to that of the vehicle 1, or may include an ECU or the like different from the driving assistance device 1100. The evacuation request screen 902 is a screen generated by the driving assistance device 1100 of the other vehicle 2 or another ECU thereof based on information included in the request for evacuation to the second evacuation candidate area 62 from the vehicle 1 to the other vehicle 2.

The request for evacuation to the second evacuation candidate area 62 from the vehicle 1 to the other vehicle 2 includes, for example, a message M2 for explaining an evacuation destination of the other vehicle 2, a fourth image 94 indicating a current position of the other vehicle 2, a fifth image 95 indicating a position of the second evacuation candidate area 62, and a sixth image 96 indicating a movement route from the current position of the other vehicle 2 to the second evacuation candidate area 62.

FIG. 12 is a diagram illustrating an example of a situation report screen 903 of the evacuation request displayed on the display 17 of the vehicle 1 according to the second embodiment. When the evacuation request is transmitted to the other vehicle 2, the output control module 172g causes the display 17 to display the situation report screen 903 of the evacuation request. The evacuation request situation report screen 903 includes, for example, a message M3 for explaining the situation of the evacuation request and a first image 91 indicating the current position of the vehicle 1.

For example, the output control module 172g continues to display the image until the wireless communication unit 110 receives approval of the evacuation request from the other vehicle 2.

In addition, when the vehicle 1 evacuates rearwards, the output control module 172g may notify the other vehicle 2 that the vehicle 1 evacuates rearwards by V2X communication or the like.

Next, a description will be given as to a flow of passing assistance processing executed by the driving assistance device 1100 of the present embodiment configured as described above.

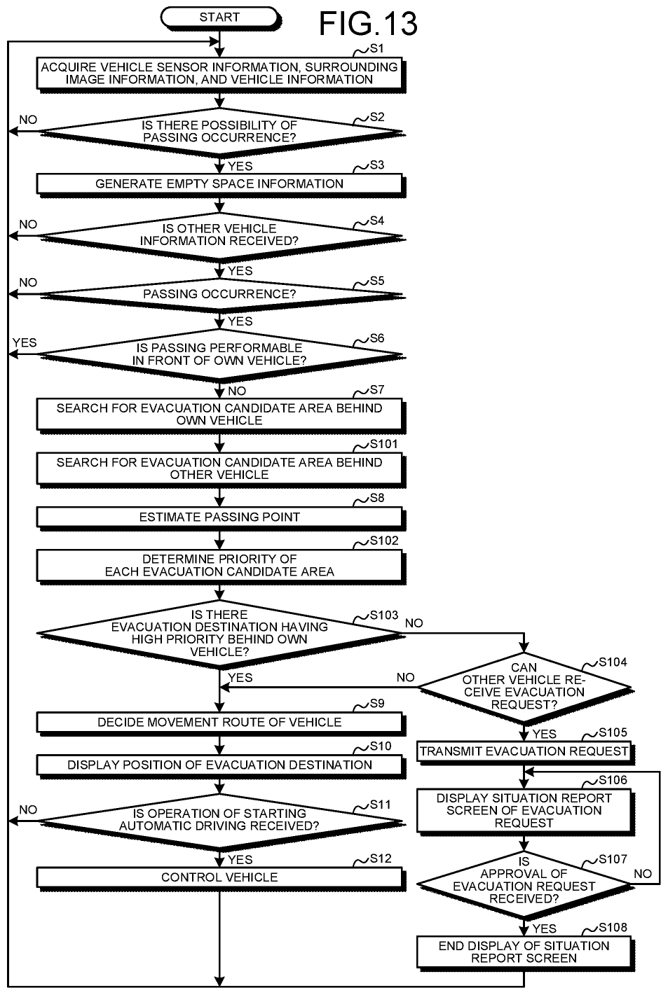

FIG. 13 is a flowchart illustrating an example of the flow of the passing assistance processing according to the second embodiment.

Pieces of processing from the acquisition processing in S1 to the processing of generating empty space information in S3 are same as those in the first embodiment. In addition, in the process of determining whether the other vehicle information 1171e has been received in S4, the other vehicle information 1171e of the present embodiment includes, in addition to the vehicle width w1 and the vehicle length d1 of the other vehicle 2 described in the first embodiment, information on the second evacuation candidate area to which the other vehicle 2 can evacuate around the traveling trajectory of the other vehicle 2. Pieces of processing from the processing of determining whether the passing occurs in S5 to the processing of searching for an evacuation candidate area behind the vehicle 1 in S7 are the same as those in the first embodiment.

Next, the search module 172d searches for the second evacuation candidate area 62 behind the other vehicle 2 based on the other vehicle information 1171e (S101).

Then, the estimation module 172e estimates the passing point 600 based on the searched first evacuation candidate area 61 and second evacuation candidate area 62 (S8).

Next, the determination module 172c determines a priority of each evacuation candidate area (S102). Then, the determination module 172c determines whether the evacuation destination having a high priority is present behind the vehicle 1 (S103). When it is determined that the evacuation destination having a high priority is present behind the vehicle 1 (S103 “Yes”), pieces of processing from the processing of deciding the movement route of the vehicle 1 to the first evacuation candidate area 61 in S9 to the processing of vehicle control in S12 are executed as in the first embodiment.

In addition, when the determination module 172c determines that the evacuation destination having a high priority is present behind the other vehicle 2 (S103 “No”), the output control module 172g determines whether the other vehicle 2 can receive an evacuation request to the other vehicle 2 (S104).

For example, when the wireless communication unit 110 transmits a communication signal to the other vehicle 2 and a response to the signal is transmitted from the other vehicle 2, the output control module 172g determines that the other vehicle 2 can receive the evacuation request to the other vehicle 2 (S104 “Yes”). In this case, the output control module 172g transmits the evacuation request to the other vehicle 2 via the communication message generation module 180 and the wireless communication unit 110 (S105).

Then, the output control module 172g displays the situation report screen 903 of the evacuation request on the display 17 (S106).

Then, while the wireless communication unit 110 has not received the approval of the evacuation request from the other vehicle 2 (S107 “No”), the output control module 172g continues to display the situation report screen 903 of the evacuation request.

When the wireless communication unit 110 receives the approval of the evacuation request from the other vehicle 2 (S107 “Yes”), the output control module 172g ends the display of the situation report screen 903 of the evacuation request (S108). Note that the end condition of the display of the situation report screen 903 of the evacuation request is not limited thereto, and the output control module 172g may end the display of the situation report screen 903 of the evacuation request after a lapse of a prescribed time. Thereafter, the processing returns to the processing in S1, and the processing of this flowchart is continuously executed while the vehicle 1 is traveling.

In addition, when it is determined that the other vehicle 2 cannot receive the evacuation request to the other vehicle 2 (S104 “No”), it is not possible to request the other vehicle 2 to evacuate rearwards. Therefore, the processing proceeds to S9, and the evacuation processing of the vehicle 1 to the rear side is executed.

As described above, the vehicle 1 of the present embodiment can mutually transmit and receive information to and from the other vehicle 2, and acquires the other vehicle information 1171e including the information related to the second evacuation candidate area 62 to which the other vehicle 2 can evacuate from the other vehicle 2. In addition, when the vehicle 1 of the present embodiment determines that it is not possible for the vehicle 1 to pass the other vehicle 2, the vehicle 1 searches for an evacuation destination of the vehicle 1 or the other vehicle 2 based on the other vehicle information 1171e and the state around the vehicle 1, and outputs information on the searched evacuation destination of the vehicle 1 or the other vehicle 2 to the display 17 and the other vehicle 2. Therefore, the vehicle 1 of the present embodiment has the same effect as that of the first embodiment, and can have assistance targets including not only the vehicle 1 configured to evacuate rearwards but also the other vehicle 2 configured to evacuate rearwards. For example, there is a case where it is difficult for a driver of the vehicle 1 to arbitrate regarding the evacuation destination to a driver of the other vehicle 2 orally or by gesture or the like. In such a situation as well, the vehicle 1 of the present embodiment can assist the smooth passing between the vehicle 1 and the other vehicle 2 by allowing the vehicle 1 or the other vehicle 2 to evacuate rearwards.

In addition, the vehicle 1 of the present embodiment determines the priority of evacuation of the vehicle 1 or the other vehicle 2 based on the state around the vehicle 1, the position and the size of the first evacuation candidate area 61, and the position and the size of the second evacuation candidate area 62 when determining that the passing between the vehicle 1 and the other vehicle 2 is not performable, and transmits, to the other vehicle 2, a request for evacuation to the second evacuation candidate area 62 when the priority of evacuation by the other vehicle 2 is higher than the priority of evacuation by the vehicle 1. Therefore, when it is difficult for the vehicle 1 of the present embodiment to evacuate rearwards, the vehicle 1 can request the other vehicle 2 to evacuate rearwards together with the information on the evacuation destination. As a result, the possibility that the other vehicle 2 evacuates rearwards is increased, thereby making it possible to assist smooth passing between the two vehicles.

First Modification

In the second embodiment described above, the case where the vehicle 1 sends an evacuation request to the other vehicle 2 has been described, but the vehicle 1 may be able to receive the evacuation request from the other vehicle 2.

For example, it is assumed that the other vehicle 2 has a function similar to that of the vehicle 1 described in the second embodiment. The output control module 172g of the vehicle 1 of the present modification transmits the vehicle information 171a including the information on the size of the vehicle body 12 of the vehicle 1 to the other vehicle 2 via the communication message generation module 180 and the wireless communication unit 110. Note that the vehicle information 171a is stored in the storage unit 171 as in the first and second embodiments.

Then, when receiving the evacuation request to the first evacuation candidate area 61 from the other vehicle 2, the output control module 172g of the present modification causes the display 17 to display a position of the first evacuation candidate area 61, the position being indicated as an evacuation destination from the other vehicle 2. For example, the output control module 172g may cause the display 17 to display a message M1 for explaining the position of the first evacuation candidate area 61, a first image 91 indicating the current position of the vehicle 1, a second image 92 indicating the position of the first evacuation candidate area 61, and a third image 93 indicating the movement route from the current position of the vehicle 1 to the first evacuation candidate area 61, similarly to the evacuation destination guidance screen 901 described with reference to FIG. 6.

In addition, when the wireless communication unit 110 receives a request to evacuate to the rear of the vehicle 1 from the other vehicle 2, the vehicle control module 190 of the present modification moves the vehicle 1 to the evacuation destination presented by the other vehicle 2 by automatic driving. For example, when the first evacuation candidate area 61 is specified by the other vehicle 2 and notified as the evacuation destination, the vehicle control module 190 moves the vehicle 1 to the first evacuation candidate area 61 by automatic driving.

As described above, with the vehicle 1 of the present modification, when an evacuation request is received from the other vehicle 2, evacuation can be performed according to the request.

Second Modification

In the first embodiment and the second embodiment described above, the vehicle 1 searches for the first evacuation candidate area 61 using the measurement result by the wave transmitter/receiver 15 and the image captured by the image capturing device 16. However, the vehicle 1 may search for the first evacuation candidate area 61 using only the image captured by the image capturing device 16.

For example, when determining that it is not possible for the vehicle 1 to pass the other vehicle 2 by moving forwards, the search module 172d of the vehicle 1 may search for the first evacuation candidate area 61 located behind the vehicle 1 based on an image obtained by capturing the periphery of the traveling trajectory of the vehicle 1 using the image capturing device 16. When the first evacuation candidate area 61 is present, the output control module 172g causes the display 17 to display information indicating the position of the first evacuation candidate area 61.

Third Modification

In addition, the vehicle 1 may not include the image capturing device 16. Furthermore, even in a case where the image capturing device 16 is provided, a captured image by the image capturing device 16 may not be used. In this case, the vehicle 1 searches for the first evacuation candidate area 61 based on the measurement result by the wave transmitter/receiver 15.

Fourth Modification

Further, when searching for the first evacuation candidate area 61, the search module 172d of the vehicle 1 may use information of a map database in addition to the measurement result by the wave transmitter/receiver 15 or the image captured by the image capturing device 16.

Fifth Modification

In the first embodiment and the second embodiment described above, the vehicle 1 has been described as having the automatic driving function, but the vehicle 1 may not have the automatic driving function.

Sixth Modification

In addition, the vehicle 1 may travel by automatic driving not only when evacuating rearwards but also when moving forwards. For example, when the determination module 172c determines that the vehicle 1 and the other vehicle 2 can move forwards and pass each other, the vehicle control module 190 may cause the vehicle 1 to move forwards and travel so as to pass the other vehicle 2.

Seventh Modification

In addition, in the first embodiment and the second embodiment described above, an example in which the vehicle 1 and the other vehicle 2 face each other on the linear road 40 has been described, but the application example of the vehicle 1 is not limited thereto.

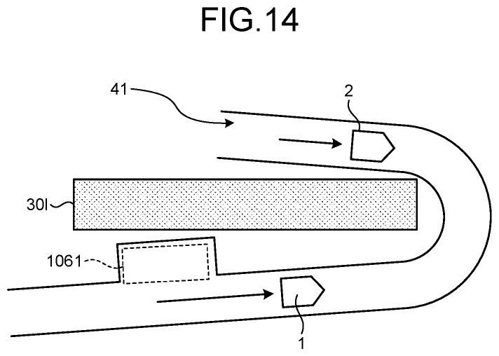

FIG. 14 is a diagram illustrating an example of a positional relationship between the vehicle 1 and the other vehicle 2 according to a seventh modification. As illustrated in FIG. 14, for example, in a case where the vehicle 1 is traveling on a road 41 having a sharp curve such as a mountain road, even when the other vehicle 2 cannot be visually recognized from the position of the vehicle 1 due to an obstacle 30l such as a curve or a tree, the wireless communication unit 110 of the vehicle 1 can receive the other vehicle information 1171e and 171e from the other vehicle by V2X communication or the like.

In the case of such a road 40 as well, the vehicle 1 can search for a first evacuation candidate area 1061 to which the vehicle 1 can evacuate based on the other vehicle information 1171e and 171e and the state around the vehicle 1 detected along the traveling trajectory of the vehicle 1 by the wave transmitter/receiver 15 or the image capturing device 16, and can assist passing between the vehicle 1 and the other vehicle 2 by allowing the vehicle 1 to evacuate to the first evacuation candidate area 1061.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A driving assistance device capable of being mounted on a vehicle,
the vehicle including:
a first wheel;
a second wheel;
a vehicle body coupled to the first wheel and the second wheel, the vehicle body being movable by the first wheel and the second wheel;
a detection device capable of detecting a state around the vehicle;
a communication unit capable of receiving, from another vehicle, other vehicle information on the other vehicle; and
a display unit visually recognizable by a driver,
the other vehicle information including information on a size of a vehicle body of the other vehicle, and
the driving assistance device comprising:
a memory; and
a processor coupled to the memory and configured to:
determine whether the vehicle and the other vehicle are allowed to pass each other based on the state around the vehicle, the information on the size of the vehicle body of the other vehicle, and a size of the vehicle body of the vehicle;
search for, when determining that passing between the vehicle and the other vehicle is not performable, a first evacuation candidate area to which the vehicle is allowed to evacuate based on the state around the vehicle detected along a traveling trajectory of the vehicle by the detection device; and
display a search result of the first evacuation candidate area on the display unit.

2. The driving assistance device according to claim 1, wherein
the processor is configured to:
determine, when the other vehicle is traveling in a same lane as the vehicle and a traveling direction of the other vehicle faces a traveling direction of the vehicle, whether the vehicle and the other vehicle are allowed to move forwards and to pass each other;
estimate, when determining that the vehicle and the other vehicle are not allowed to move forwards and to pass each other, a passing point at which the passing between the vehicle and the other vehicle is performable by allowing the vehicle to evacuate to the first evacuation candidate area to which the vehicle is allowed to evacuate; and
display, on the display unit, a movement route up to the first evacuation candidate area specified as an evacuation destination configured to enable the vehicle and the other vehicle to pass each other at the estimated passing point.

3. The driving assistance device according to claim 1, wherein
the processor is configured to cause, when determining that the vehicle and the other vehicle are not allowed to move forwards and to pass each other, the vehicle to move to the first evacuation candidate area by automatic driving.

4. The driving assistance device according to claim 1, wherein
the memory is configured to store information on the first evacuation candidate area around the traveling trajectory of the vehicle, and
the processor is configured to extract, as the first evacuation candidate area, an empty space existing around the traveling trajectory of the vehicle and having a prescribed size or more during traveling of the vehicle based on a state around the traveling trajectory of the vehicle detected by the detection device, and to store the extracted empty space in the memory.

5. The driving assistance device according to claim 1, wherein
the detection device includes an image capturing device capable of capturing an image around the vehicle, and
the processor is configured to:
search for, when determining that the passing between the vehicle and the other vehicle is not performable, the first evacuation candidate area located behind the vehicle based on an image around the traveling trajectory of the vehicle captured by the image capturing device; and
cause, when the first evacuation candidate area exists, the display unit to display information indicating a position of the first evacuation candidate area.

6. The driving assistance device according to claim 1, wherein
the other vehicle information includes information on a second evacuation candidate area to which the other vehicle is allowed to evacuate, the second evacuation candidate area existing around a traveling trajectory of the other vehicle, and
the processor is configured to:
search for, when determining that the passing between the vehicle and the other vehicle is not performable, an evacuation destination of the vehicle or the other vehicle based on the other vehicle information and the state around the vehicle, and
output, to the display unit and the other vehicle, information on the searched evacuation destination of the vehicle or the other vehicle.

7. The driving assistance device according to claim 6, wherein
the processor is configured to:
determine, when determining that the passing between the vehicle and the other vehicle is not performable, a priority of evacuation of the vehicle or the other vehicle based on the state around the vehicle, a position and a size of the first evacuation candidate area, and a position and a size of the second evacuation candidate area, and
transmit, to the other vehicle, an evacuation request to the second evacuation candidate area when the priority of evacuation by the other vehicle is higher than the priority of evacuation by the vehicle.

8. The driving assistance device according to claim 6, wherein
the memory is configured to store vehicle information including information on the size of the vehicle body of the vehicle, and
the processor is configured to:
transmit the vehicle information to the other vehicle; and
display, when receiving an evacuation request to the first evacuation candidate area from the other vehicle, a position of the first evacuation candidate area indicated as the evacuation destination from the other vehicle on the display unit.

9. The driving assistance device according to claim 6, wherein
the processor is configured to cause the vehicle to move to the first evacuation candidate area by the automatic driving when receiving, from the other vehicle, a request to evacuate to a rear of the vehicle.

10. The driving assistance device according to claim 1, wherein
the detection device is capable of detecting a following vehicle of the vehicle, and
the state around the vehicle includes presence or absence of the following vehicle of the vehicle.

11. The driving assistance device according to claim 2, wherein
the processor is configured to determine whether the vehicle and the other vehicle are allowed to move forwards and pass each other based on a width of a road on which the vehicle travels, a width of the vehicle body of the vehicle, a width of the vehicle body of the other vehicle included in the other vehicle information, and a prescribed buffer distance in a vehicle width direction, and
the prescribed buffer distance in the vehicle width direction is a sum of a lower limit value of a distance in the vehicle width direction between the vehicle and the other vehicle and a lower limit value of a distance between left and right obstacles of the vehicle and the other vehicle when the vehicle and the other vehicle pass each other.

12. The driving assistance device according to claim 11, wherein the processor is configured to determine that the vehicle and the other vehicle are not allowed to move forwards and to pass each other when the width of the road is less than a value obtained by summing the width of the vehicle body of the vehicle, the width of the vehicle body of the other vehicle, and the prescribed buffer distance.

13. The driving assistance device according to claim 2, wherein the processor is configured to determine, when there is a section in which a sum of a distance from the vehicle to an obstacle on a right side of the vehicle and a distance from the vehicle to an obstacle on a left side of the vehicle is equal to or greater than a sum of a vehicle width of the other vehicle and a prescribed buffer distance in a vehicle width direction, and a length of the section is equal to or greater than a sum of a vehicle length of the vehicle and a prescribed buffer distance in a vehicle length direction, the section as the passing point.
